(19) United States
(12) Patent Application Publication
(10) Pub. No.: US 2023/0299398 A1
(43) Pub. Date: Sep. 21, 2023

(54) RECHARGEABLE-BATTERY CELL

(71) Applicant: SK On Co., Ltd., Seoul (KR)

(72) Inventors: Young Ha KIM, Daejeon (KR); Ji Hyung KIM, Daejeon (KR); Sang Bin LEE, Daejeon (KR); Ho Jin HWANG, Daejeon (KR)

(21) Appl. No.: 18/098,111

(22) Filed: Jan. 18, 2023

(30) Foreign Application Priority Data
Mar. 21, 2022 (KR) 10-2022-0034552

(51) Int. Cl. H01M 50/184; H01M 50/186; H01M 50/30

(52) U.S. Cl. CPC H01M 50/184; H01M 50/186; H01M 50/30

(57) ABSTRACT

A rechargeable-battery cell includes: an electrode assembly including a first electrode plate, a separator, and a second electrode plate; an electrode lead portion connected to a first or second uncoated electrode portion extending from the first or second electrode plate of the electrode assembly; a sealing member through which the electrode lead portion passes; and an exterior material from which portions of the sealing member and the electrode lead portion are externally exposed and in which the electrode structure is disposed, wherein the sealing member has the same thickness as or a thickness smaller than that of the electrode assembly.

### CROSS-REFERENCE TO RELATED APPLICATION(S)

This application claims benefit of priority to Korean Patent Application No. 10-2022-0034552 filed on Mar. 21, 2022 in the Korean Intellectual Property Office, the disclosure of which is incorporated herein by reference in its entirety.

### BACKGROUND

### 1. Field

The present disclosure relates to a rechargeable-battery cell.

### 2. Description of Related Art

A pouch-type secondary battery may be classified as a unidirectional pouch-type secondary battery or a bi-directional pouch-type secondary battery, based on a direction of an electrode lead, and classified as a three-side sealing pouch-type secondary battery or a four-side sealing pouch-type secondary battery based on the number of sealing surfaces.

Meanwhile, the three-side sealing pouch-type secondary battery may have a non-sealing surface, both ends of which protrude, which is generally referred to with various names such as shark-fins and bat ears.

Meanwhile, the plurality of pouch-type secondary batteries may be accommodated in a case or the like to be manufactured as a secondary battery module or a secondary battery pack.

However, the secondary battery module or the secondary battery pack may have a volume density lower as well as a lower cooling efficiency due to these protruding portions during manufacturing thereof.

### SUMMARY

An aspect of the present disclosure may provide a rechargeable-battery cell including no protruding portion.

According to an aspect of the present disclosure, a rechargeable-battery cell may include: an electrode assembly including a first electrode plate, a separator, and a second electrode plate; an electrode lead portion connected to a first or second uncoated electrode portion extending from the first or second electrode plate of the electrode assembly; a sealing member through which the electrode lead portion passes; and an exterior material from which portions of the sealing member and the electrode lead portion are externally exposed and in which the electrode structure is disposed, wherein the sealing member has the same thickness as or a thickness smaller than that of the electrode assembly.

The sealing member may have the same overall thickness.

A thickness difference between the sealing member and the electrode assembly may be 2 mm or less.

A thickness of one end of the sealing member and a thickness of the other end of the sealing member may be different from each other.

The thickness of one end of the sealing member may be greater than the thickness of the other end of the sealing member, and the thickness of the one end of the sealing member may be the same as or smaller than that of the electrode assembly.

A difference between the thickness of the one end of the sealing member and that of the electrode assembly may be 2 mm or less.

The sealing member may have a hexahedral shape.

The sealing member may include a venting hole for venting a gas.

The sealing member may be disposed at each of two ends of the electrode assembly.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic perspective view showing a rechargeable-battery cell according to an exemplary embodiment of present disclosure;

FIG. 2 is an exploded perspective view showing the rechargeable-battery cell according to an exemplary embodiment of the present disclosure;

FIG. 3 is an illustrative diagram for explaining a sealing member of the rechargeable-battery cell according to an exemplary embodiment of present disclosure;

FIG. 4 is an illustrative diagram for explaining a modified example of the sealing member included in the rechargeable-battery cell according to an exemplary embodiment of present disclosure; and

FIG. 5 is an illustrative diagram for explaining another modified example of the sealing member included in the rechargeable-battery cell according to an exemplary embodiment of present disclosure.

### DETAILED DESCRIPTION

Hereinafter, exemplary embodiments of the present disclosure will now be described in detail with reference to the accompanying drawings.

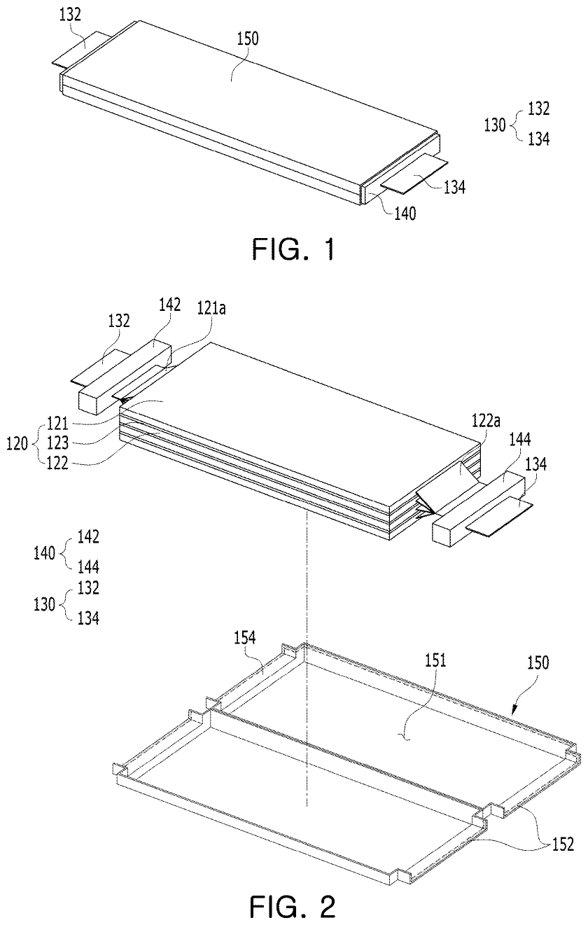

FIG. 1 is a schematic perspective view showing a rechargeable-battery cell according to an exemplary embodiment of present disclosure; and FIG. 2 is an exploded perspective view showing the rechargeable-battery cell according to an exemplary embodiment of the present disclosure.

Referring to FIGS. 1 and 2, a rechargeable-battery cell 100 according to an exemplary embodiment of the present disclosure maybe an example, and include an electrode assembly 120, an electrode lead portion 130, a sealing member 140, and an exterior material 150.

The electrode assembly 120 may be accommodated in an inner space formed by the sealing member 140 and the exterior material 150. For example, the electrode assembly 120 may include a first electrode plate 121, a second electrode plate 122, and a separator 123 having a thin plate shape or a film shape, and be various types as necessary, such as a laminated type and a winding type. For example, the first electrode plate 121 may serve as a negative pole and the second electrode plate 122 may serve as a positive pole.

The first electrode plate 121 may be made by coating a first electrode active material such as graphite or carbon on a first electrode current collector made of a metal foil made of copper, copper alloy, nickel, or a nickel alloy, for example. In addition, the first electrode plate 121 may include a first uncoated electrode portion 121a which is a region on which the first electrode active material is not coated. The first uncoated electrode portion 121a may serve as a passage for a current flow between the first electrode plate 121 and the outside of the first electrode plate 121.

The second electrode plate 122 may be made by coating a second electrode active material such as transition metal oxide on a second electrode current collector made of a metal foil made of aluminum or aluminum alloy, for example. In addition, the second electrode plate 122 may include a second uncoated electrode portion 122a which is a region on which the second electrode active material is not coated. The second uncoated electrode portion 122a may also serve as a passage for current flow between the second electrode plate 122 and the outside of the second electrode plate 122.

The separator 123 may be positioned between the first electrode plate 121 and the second electrode plate 122 to prevent a short circuit and enable movement of lithium ions. For example, the separator 123 may be made of polyethylene, polypropylene, or a composite film made of polyethylene and polypropylene.

For example, the first electrode plate 121, the second electrode plate 122, and the separator 123 may be arranged in a height direction of the sealing member 140. In other words, the first electrode plate 121, the separator 123, and the second electrode plate 122 may be alternately laminated sequentially in a Z-axis direction in FIG. 2.

The electrode lead portion 130 may be connected to the first or second uncoated electrode portion 121a or 122a extending from the first or second electrode plate 121 or 122 of the electrode assembly 120. For example, the electrode lead portion 130 may pass through the sealing member 140 and a portion thereof may be externally exposed. In addition, the electrode lead portion 130 may serve as a passage for the current flow between the first or second electrode plate 121 or 122 and the outside. To this end, the electrode lead portion 130 may be made of a conductive material. Meanwhile, the electrode lead portion 130 may include a first electrode lead portion 132 connected to the first uncoated electrode portion 121a and a second electrode lead portion 134 connected to the second uncoated electrode portion 122a.

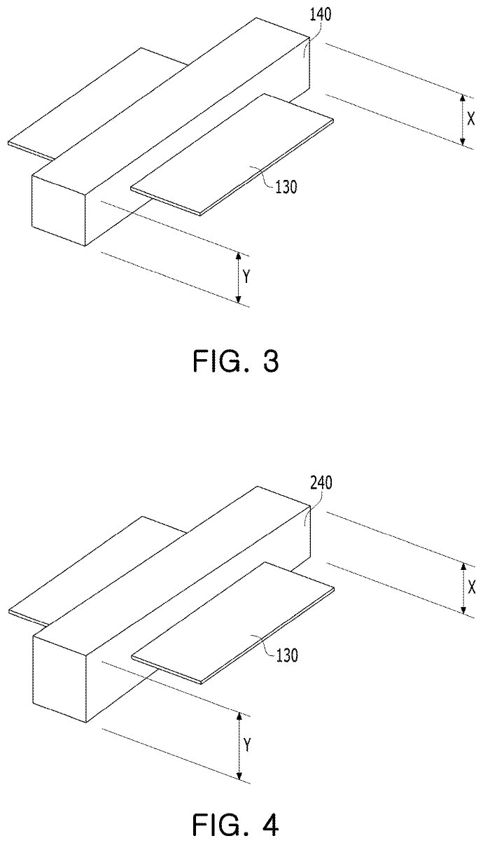

The sealing member 140 may be disposed at each of two ends of the electrode assembly 120, and the electrode lead portion 130 may pass through the sealing member 140. For example, the sealing member 140 may include a first sealing member 142 through which the first electrode lead 132 passes and a second sealing member 144 through which the second electrode lead 134 passes. For example, the sealing member 140 may have the same thickness as or a similar thickness to that of the electrode assembly 120. In addition, the sealing member 140 may have the same overall thickness. In other words, a thickness X of one end of the sealing member 140 shown in FIG. 3 and a thickness Y of the other end of the sealing member 140 may be the same as each other.

As such, the sealing member 140 may have the same thickness as or the similar thickness to that of the electrode assembly 120, and the thickness Y of one end of the sealing member 140 and the thickness X of the other end of the sealing member 140 may be the same as each other. In this case, the exterior material 150 may not have any step, thus including no protruding portion (i.e., shark-fin or bat ear) even when surrounding the electrode assembly 120 and the sealing member 140. In other words, the exterior material 150 may not have any step caused by a thickness difference between the electrode assembly 120 and the sealing member 140, thus including no protruding portion (i.e., shark-fin or bat ear) even when surrounding the electrode assembly 120 and the sealing member 140.

Meanwhile, the sealing member 140 may have a thickness similar to that of the electrode assembly 120, and in this case, the thickness difference between the sealing member 140 and the electrode assembly 120 may be 2 mm or less. Even in this case, the exterior material 150 may hardly have any step caused by the thickness difference between the electrode assembly 120 and the sealing member 140, thus including no protruding portion (i.e., shark-fin or bat ear) even when surrounding the electrode assembly 120 and the sealing member 140. On the other hand, if the thickness difference between the sealing member 140 and the electrode assembly 120 is greater than 2 mm, a risk that the exterior material 150 includes the protruding portion (i.e., shark-fin or bat ear) may be increased due to the step caused by the thickness difference between the electrode assembly 120 and the sealing member 140 when the exterior material 150 surrounds the electrode assembly 120 and the sealing member 140. However, the thickness difference between the sealing member 140 and the electrode assembly 120 is 2 mm or less, and accordingly, the exterior material 150 may not include any protruding portion (i.e., shark-fin or bat ear) caused by the step when surrounding the electrode assembly 120 and the sealing member 140.

In addition, the sealing member 140 may have a substantially rectangular parallelepiped shape.

For example, the sealing member 140 may be made of an insulating material. In addition, the exterior material 150 may be made of a material that does not absorb an electrolyte solution accommodated inside. Accordingly, electrical interference (short circuit or the like) with the electrode lead portion 130 may not occur even when the sealing member 140 is installed in the exterior material 150, thus preventing an electrolyte from leaking through the sealing member 140.

The exterior material 150 may be disposed in such a manner that portions of the sealing member 140 and the electrode lead portion 130 are externally exposed therethrough, and the electrode assembly 120 may be disposed therein. In other words, the exterior material 150 and the sealing member 140 may form an inner space for accommodating the electrode assembly 120, and the electrode assembly 120 may be disposed in the inner space formed by the exterior material 150 and the sealing member 140.

Meanwhile, the exterior material 150 may be made of a laminate sheet including a metal layer and a resin layer. In particular, the laminate sheet may be an aluminum laminate sheet. For example, the exterior material 150 may include a core portion made of the metal layer, a heat sealing layer positioned on an upper surface of the core portion, and an insulating film positioned on a lower surface of the core portion.

The heat-sealing layer may act as an adhesive layer by using a polymer resin such as modified polypropylene, such as casted polypropylene (CPP), and the insulating film may be made of a resin material such as nylon or polyethylene terephthalate (PET), and the structure and material of the exterior material 150 are not limited hereto.

For example, the exterior material 150 may include an accommodating part 151 which is a space for accommodating the electrode assembly 120, and the electrode assembly 120 may be disposed in the accommodating part 151. Meanwhile, the exterior material 150 may include a mounting part 154 which is disposed at an end of the accommodating part 151 and in which the sealing member 140 is disposed. The mounting part 154 may surround the sealing member 140 and have a smaller width than a width of the accommodating part 151. Furthermore, a sealing part 152 may be partially positioned in a region in which the exterior material 150 and the sealing member 140 are in contact with each other or a region in which the exterior materials 150 overlap each other. The sealing part 152 may serve to prevent external leakage of the electrolyte solution accommodated in the inner space of the exterior material 150. For example, an auxiliary sealing agent such as an adhesive or an implant may be interposed between the sealing parts 152.

As such, the exterior material 150 may surround the sealing member 140 and the electrode assembly 120 having the same or similar thicknesses, thus including no protruding portion (i.e., shark-fin or bat ear) even after including the sealing part 152. In other words, the exterior material 150 may prevent any protruding portion formed thereon, which is formed by the step occurring between the sealing part and the electrode assembly while the exterior materials 150 overlap each other.

Meanwhile, the electrolyte solution may fill the inner space formed by the exterior material 150 and the sealing member 140. For example, the electrolyte solution may be a lithium salt such as LiPF₆ or LiBF₄ in an organic solvent such as ethylene carbonate (EC), propylene carbonate (PC), diethyl carbonate (DEC), ethylmethyl carbonate (EMC), or dimethyl carbonate (DMC). In addition, the electrolyte solution may be liquid or gel.

As such, the exterior material 150 may surround the sealing member 140 and the electrode assembly 120 having the same or similar thicknesses, thus including no protruding portion (i.e., shark-fin or bat ear) even after including the sealing part 152.

FIG. 4 is an illustrative diagram for explaining a modified example of the sealing member included in the rechargeable-battery cell according to an exemplary embodiment of present disclosure.

Referring to FIG. 4, a sealing member 240 may be disposed at each of two ends of the electrode assembly 120, and the electrode lead portion 130 passes through may pass through the sealing member 240. For example, the sealing member 240 may include a first sealing member 242 through which the first electrode lead 132 passes and a second sealing member 244 through which the second electrode lead 234 passes. For example, the sealing member 240 may have the same thickness as or a similar thickness to that of the electrode assembly 120.

In addition, as shown in FIG. 4, the thickness Y of one end of the sealing member 240 may be greater than the thickness X of the other end of the sealing member 240. As such, the thickness Y of one end of the sealing member 240 may be greater than the thickness X of the other end of the sealing member 240, and it is thus possible to prevent the step caused by the sealing part 152 (see FIG. 2) formed while the exterior materials 150 overlap each other even when the exterior material 150 (see FIG. 2) surrounds the sealing member 240. In other words, it is possible to reduce the occurrence of the step caused by the sealing part 152 by disposing the sealing part 152 to overlap the exterior material 150 at the other end of the sealing member 240.

In addition, the thickness Y of the other end of the sealing member 240 may be the same as that of the electrode assembly 120. In this case, the exterior material 150 may not have any step, thus including no protruding portion (i.e., shark-fin or bat ear) even when surrounding the electrode assembly 120 and the sealing member 240. In other words, the exterior material 150 may not have any step caused by a thickness difference between the electrode assembly 120 and the sealing member 240, thus including no protruding portion (i.e., shark-fin or bat ear) even when surrounding the electrode assembly 120 and the sealing member 240.

For example, the difference between the thickness Y of one end of the sealing member 240 and that of the electrode assembly 120 maybe 2 mm or less. Even in this case, the exterior material 150 may hardly have any step caused by the thickness difference between the electrode assembly 120 and the sealing member 240, thus including no protruding portion (i.e., shark-fin or bat ear) even when surrounding the electrode assembly 120 and the sealing member 240. On the other hand, if the thickness difference between the sealing member 240 and the electrode assembly 120 is greater than 2 mm, a risk that the exterior material 150 includes the protruding portion (i.e., shark-fin or bat ear) may be increased due to the step caused by the thickness difference between the electrode assembly 120 and the sealing member 240 when the exterior material 150 surrounds the electrode assembly 120 and the sealing member 240. However, the thickness difference between the sealing member 240 and the electrode assembly 120 is 2 mm or less, and accordingly, the exterior material 150 may not include any protruding portion (i.e., shark-fin or bat ear) caused by the step when surrounding the electrode assembly 120 and the sealing member 240.

Meanwhile, the sealing member 240 may have a hexahedral shape. In other words, the sealing member 240 may have a trapezoidal cross section.

As such, the exterior material 150 may surround the sealing member 240 and the electrode assembly 120 having the same or similar thicknesses, thus including no protruding portion (i.e., shark-fin or bat ear) even after including the sealing part 152.

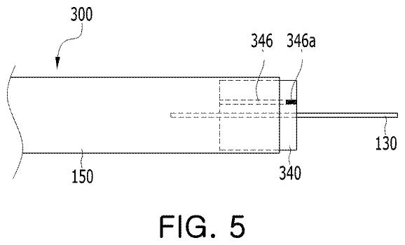

FIG. 5 is an illustrative diagram for explaining another modified example of the sealing member included in the rechargeable-battery cell according to an exemplary embodiment of present disclosure.

Referring to FIG. 5, a rechargeable-battery cell 300 may include, for example, the electrode assembly 120 (see FIG. 2), the electrode lead portion 130, a sealing member 340, and the exterior material 150.

The sealing member 340 may be disposed at each of two ends of the electrode assembly 120 (see FIG. 2), and the electrode lead portion 130 may pass through the sealing member 340.

For example, the sealing member 340 may have the same thickness as or a similar thickness to that of the electrode assembly 120. In addition, the sealing member 340 may have the same overall thickness.

As such, when the sealing member 340 has the same overall thickness, the exterior material 150 may not have any step, thus including no protruding portion (i.e., shark-fin or bat ear) even when surrounding the electrode assembly 120 and the sealing member 340. In other words, the exterior material 150 may not have any step caused by a thickness difference between the electrode assembly 120 and the sealing member 340, thus including no protruding portion (i.e., shark-fin or bat ear) even when surrounding the electrode assembly 120 and the sealing member 340.

Meanwhile, the sealing member 340 may have the thickness similar to that of the electrode assembly 120, and in this case, the thickness difference between the sealing member 340 and the electrode assembly 120 may be 2 mm or less. Even in this case, the exterior material 150 may hardly have any step caused by the thickness difference between the electrode assembly 120 and the sealing member 340, thus including no protruding portion (i.e., shark-fin or bat ear) even when surrounding the electrode assembly 120 and the sealing member 340. On the other hand, if the thickness difference between the sealing member 340 and the electrode assembly 120 is greater than 2 mm, a risk that the exterior material 150 includes the protruding portion (i.e., shark-fin or bat ear) may be increased due to the step caused by the thickness difference between the electrode assembly 120 and the sealing member 340 when the exterior material 150 surrounds the electrode assembly 120 and the sealing member 340. However, the thickness difference between the sealing member 340 and the electrode assembly 120 is 2 mm or less, and accordingly, the exterior material 150 may not include any protruding portion (i.e., shark-fin or bat ear) caused by the step when surrounding the electrode assembly 120 and the sealing member 340.

In addition, the sealing member 340 may have the substantially rectangular parallelepiped shape.

Meanwhile, the sealing member 340 may include a venting hole 346 for venting a gas. A venting member 346a may be installed in the venting hole 346. That is, the gas may occur in an inner space of the sealing member 340 that is formed by the exterior material 150 and the sealing member 340 to increase an internal pressure. In this case, when the internal pressure is increased to a predetermined pressure or more, the venting member 346a may be damaged, and the gas may thus leak through the venting hole 346. Accordingly, it is possible to prevent explosion of the rechargeable-battery cell 300.

For example, a detection member (not shown) for detecting the gas leakage maybe additionally installed in the venting hole 346. A user may recognize a venting time of the rechargeable-battery cell 300 by the detection member.

As such, the exterior material 150 may surround the sealing member 340 and the electrode assembly 120 having the same or similar thicknesses, thus including no protruding portion (i.e., shark-fin or bat ear) even after including the sealing part 152 (see FIG. 2).

As set forth above, an exemplary embodiment of the present disclosure may provide the rechargeable-battery cell including no protruding portion.

While the exemplary embodiments have been shown and described above, it will be apparent to those skilled in the art that modifications and variations could be made without departing from the scope of the present disclosure as defined by the appended claims.

What is claimed is:

1. A rechargeable-battery cell comprising:
an electrode assembly including a first electrode plate, a separator, and a second electrode plate;
an electrode lead portion connected to a first or second uncoated electrode portion extending from the first or second electrode plate of the electrode assembly;
a sealing member through which the electrode lead portion passes; and
an exterior material from which portions of the sealing member and the electrode lead portion are externally exposed and in which the electrode structure is disposed,
wherein the sealing member has the same thickness as or a thickness smaller than that of the electrode assembly.

2. The battery cell of claim 1, wherein the sealing member has the same overall thickness.

3. The battery cell of claim 1, wherein a thickness difference between the sealing member and the electrode assembly is 2 mm or less.

4. The battery cell of claim 1, wherein a thickness of one end of the sealing member and a thickness of the other end of the sealing member are different from each other.

5. The battery cell of claim 3, wherein the thickness of one end of the sealing member is greater than the thickness of the other end of the sealing member, and the thickness of the one end of the sealing member is the same as or smaller than that of the electrode assembly.

6. The battery cell of claim 5, wherein a difference between the thickness of the one end of the sealing member and that of the electrode assembly is 2 mm or less.

7. The battery cell of claim 1, wherein the sealing member has a hexahedral shape.

8. The battery cell of claim 1, wherein the sealing member includes a venting hole for venting a gas.

9. The battery cell of claim 1, wherein the sealing member is disposed at each of two ends of the electrode assembly.
